(19) United States
(12) Patent Application Publication
(10) Pub. No.: US 2024/0384937 A1
(43) Pub. Date: Nov. 21, 2024

(54) Apparatus and method for heating process media in a fiber molding process

(71) Applicant: Kiefel GmbH, Freilassing (DE)

(72) Inventors: Thomas Auer, Saaldorf-Surheim (DE); Hubert Rehrl, Teisendorf (DE); Josef Rehrl, Teisendorf (DE); Heinz Neuhofer, Freilassing (DE); Raphael Köppl, Bischofswiesen (DE)

(21) Appl. No.: 18/666,113

(22) Filed: May 16, 2024

(30) Foreign Application Priority Data
May 16, 2023 (DE) 10 2023 112 876.0

(51) Int. Cl. F28D 7/10; B29C 43/52; F28D 21/00; F28F 1/06

(52) U.S. Cl. CPC F28D 7/106; B29C 43/52; F28F 1/06; F28D 2021/0056

(57) ABSTRACT

An apparatus and a method for heating process media in a fiber molding process are described, whereby an optimization of the efficiency in the production of three-dimensional molded parts from a fiber-containing material is provided. Here, a process medium with a relatively high temperature is guided through an apparatus for heat exchange within a container with another process medium.

### PRIORITY CLAIM

The present application claims priority under 35 U.S.C. § 119 to German Patent Application No. DE 10 2023 112 876.0, filed May 16, 2023, the disclosure of which is incorporated by reference herein in its entirety.

### TECHNICAL FIELD

An apparatus and a method for heating process media in a fiber molding process are described.

### DESCRIPTION OF RELATED ART

Fiber-containing materials are increasingly used, for example, to produce packaging for food (e.g., trays, capsules, boxes, etc.) and consumer goods (e.g., electronic devices, etc.) as well as beverage containers. Everyday items, such as disposable cutlery and tableware, are also made from fiber-containing material. Fiber-containing materials contain natural fibers or artificial fibers. Recently, fiber-containing material is increasingly used that has or is made of natural fibers that can be obtained, for example, from renewable raw materials or waste paper. The natural fibers are mixed in a so-called pulp with water and optionally further additives, such as starch. Additives can also have an effect on color, barrier properties and mechanical properties. This pulp can have a proportion of natural fibers of, for example, 0.1 to 10 wt. %. The proportion of natural fibers varies depending on the method used for the production of packaging etc. and the product properties of the product to be produced.

The production of fiber-containing products from a pulp generally takes place in several work steps. For this purpose, a fiber processing device has multiple stations or forming stations. In a forming station, for example, fibers can be suctioned in a cavity of a suction tool, thus forming a preform. For this purpose, the pulp is provided in a pulp supply, and the suction tool is at least partially immersed in the pulp with at least one suction cavity whose geometry essentially corresponds to the product to be manufactured. During the immersion, suction takes place via openings in the suction cavity, which are connected to a corresponding suction device, wherein fibers from the pulp accumulate on the surface of the suction cavity. The suctioned fibers or a preform can subsequently be brought into a pre-pressing tool via the suction tool, and the preform is pre-pressed. For this purpose, for example, it is possible to use elastic molded bodies that are inflated in order to press and, in the process, exert pressure on the preforms. During this pre-pressing process, the fibers in the preform are compressed and the water content of the preform is reduced. Alternatively, preforms can be provided by means of scooping, wherein a scoop tool is immersed in the pulp and during startup fibers are deposited on molded parts of the scoop tool.

After this, preforms are pressed in a hot press to form finished molded parts. In this process, preforms are inserted into a hot press tool that has, for example, a lower tool half and an upper tool half that are heated. In the hot press tool, the preforms are pressed in a cavity under heat input, with residual moisture being removed by the pressure and heat so that the moisture content of the preforms is reduced from about 60 wt. % before hot pressing to, for example, 5-10 wt. % after hot pressing. The steam produced during hot pressing is suctioned off during the hot pressing via openings in the cavities and channels in the hot press tool. The hot steam must be cooled for safety reasons and for process stability (humid environment) before it can be removed or discharged from a fiber processing device.

A production method and a system therefor are known, for example, from DE 10 2019 127 562 A1.

Overall, the fiber processing devices known from the prior art and, in particular, the methods for operating fiber processing devices for molding fiber-containing material to produce three-dimensional molded parts are very energy-intensive and must therefore be considered disadvantageous in terms of energy requirements. Furthermore, the individual process steps have great potential for improvement in terms of cycle time and product quality results, which could previously only be solved by a further high energy input.

### SUMMARY

### Object

In contrast to the foregoing, it is an object of the present disclosure to specify a solution that, while improving the product quality of molded parts made of a fiber-containing material, reduces the energy requirement of the process steps and the manufacturing method and at the same time optimizes the process steps and the manufacturing method so that cycle times are reduced. Furthermore, it is an object of the present disclosure to increase the efficiency in the production of molded parts from a fiber-containing material.

### Solution

The above-mentioned object is achieved by an apparatus for heating process media in a fiber molding process, including a double pipe assembly made of an at least sectionally heat-conducting material, where at least a heat-conducting section of the double pipe assembly is accommodated in a container that is filled with a first process medium, where the double pipe assembly has at least a first pipe assembly and at least a second pipe assembly, where the first pipe assembly has a larger diameter than the at least second pipe assembly, and the at least second pipe assembly is accommodated at least sectionally within the first pipe assembly, further having connections for connecting the double pipe assembly to units for providing process media, where a second process medium can be guided within the second pipe assembly, and a third process medium can be guided within the first pipe assembly.

Various process media are involved in a fiber molding procedure. This includes, for example, an aqueous fiber solution (pulp) that is accommodated as the first process medium in a pulp container. Process media involved in the fiber molding process include, for example, process air for discharging steam during a hot pressing process, for sucking preforms, and for preforming sucked fibers. The process media can have different temperatures, where these are usually at ambient temperature. Only the steam arising during the hot pressing process, which is sucked in via openings and channels in the cavities of a hot press tool and discharged from the hot press tool with the aid of an additional air flow, has a relatively high temperature (e.g., 160 to 300° C.). This humid air flow is considered as a second process medium. The additional air flow before being introduced into the hot press tool can be regarded as an additional process medium or process air.

It has been found that an increase in the temperature of the process media, in particular pulp and process air, has a positive effect on the energy requirement of a fiber processing device and a fiber molding process as a whole, individual process steps and the efficiency, where the temperature difference between regularly prevailing process temperatures for the process media and their initial temperature can be significantly reduced so that, for example, the process air is better saturated with water, and there is less cooling of tools.

For this purpose, the apparatus for heating process media in a fiber molding process is supplied with the steam arising in a hot pressing process as a second process medium, which then provides (pre) heating of further process media (first process medium: pulp; second process medium: process air) of a fiber molding process via the apparatus serving as a heat exchange apparatus. The design of the apparatus makes it possible to heat both the first process medium inside the container as well as the third process medium guided in the second pipe assembly in the interior of the first pipe assembly via the second process medium (steam).

The heat transfer takes place via the condensation energy of the steam that heats the process media in contact with the heat-conducting surfaces. Depending on the design of the double pipe assembly (length, diameter, material, geometry, wall thickness, thermal conductivity, etc.), a significant influence can be exerted on the heat transfer between the process media. The double pipe assembly can, for example, run meanderingly through the container in at least one plane and also extend over a floor and/or at least one side wall surface.

The term double pipe assembly does not exclude that multiple pipes can run within a main pipe, where, for example, at least two first pipe assemblies, through which hot steam flows for example in a countercurrent or cocurrent, run within a pulp container.

In the context of the technical teaching disclosed herein, the term “pipe” also includes hoses and the like that can be used in accordance with the described purpose and achieve the desired result.

In further embodiments, the at least second pipe assembly can be accommodated only within a section within the first pipe assembly, whereby the heat absorption via the steam (second process medium) is limited to this section. Such a design can be advantageous, for example, if only slight heating is to occur. It should be noted that the second pipe assembly can also pass through the first process medium (pulp) that has a different temperature than the second and third process media. In further embodiments, second, third, fourth and further pipe assemblies can always only run sectionally within the first pipe assembly in multiple sections lying one behind the other, where these pipe assemblies can have overlapping sections. Depending on the position of these sections and their length, it is possible to influence how strong heating thereby can be. The diameters of the sections can also be adjusted to have an additional influence on the heating. Furthermore, the heating can be controlled by the speed and pressure of the process media in the pipe assemblies.

Outside a receiving space for the first process medium, in this case the pulp, at least the lines and pipes that discharge a process medium heated inside the container and introduce the second process medium from a hot press tool into the container can have insulation so that no heat losses occur, and the efficiency is additionally increased, and the overall energy requirement is reduced.

In further embodiments, at least a third pipe assembly can be arranged at least sectionally within the first pipe assembly and/or within the second pipe assembly. This can be used to heat other process media. For example, process air can be brought to different temperatures for different processes.

In further embodiments, the at least second pipe assembly within the container can open into the first pipe assembly in a receiving space for a first process medium and/or can be led out of the first pipe assembly.

In further embodiments, the diameter of the first pipe assembly and/or the at least second pipe assembly within the container may vary. By changing the diameter, for example, the heat transfer can be influenced, e.g., in order to continue to provide a desired heat transfer with a constantly supplied quantity of a process medium at a decreasing temperature along the pipe assembly.

In further embodiments, the first pipe assembly and the at least second pipe assembly can each have separately controllable connections for introducing and discharging process media so that different requirements and conditions can be influenced, for example in order to maintain an increase in process media within a predeterminable temperature range. For example, a connection can also prevent the supply of a process medium if this ensures that other process media with a higher prioritization can continue to be supplied with the required heating.

In further embodiments, the quantity and speed of the process media introduced into the double-pipe assembly can be controlled separately so that it is also possible to influence various requirements and influences.

In further embodiments, the first pipe assembly and/or the at least second pipe assembly can be designed as a corrugated pipe at least in a region of the container in a receiving space for a first process medium. Corrugated pipes have the advantage of a relatively large surface over a short distance and are therefore advantageous as heat transfer elements for good heat transfer.

The above-mentioned object is also achieved by a method for heating process media in a fiber molding process using an apparatus with a double pipe assembly made of a material that conducts heat at least sectionally according to one of the above-described embodiments, where at least a heat-conducting section of the double pipe assembly is accommodated in a container that is filled with a first process medium, where the double-pipe assembly has at least a first pipe assembly and at least a second pipe assembly, where the first pipe assembly has a larger diameter than the at least second pipe assembly, and the at least second pipe assembly is accommodated at least sectionally within the first pipe assembly, further including connections for connecting the double pipe assembly to units for providing process media, where a second process medium is guided within the second pipe assembly, and a third process medium is guided within the first pipe assembly, and where the second process medium guided in the first pipe assembly is supplied from a process step of the fiber molding process at a higher temperature, where the temperature of the second process medium is higher than the temperature of the first process medium and the third process medium guided in the at least second pipe assembly.

By heating the process media via the second process medium that is supplied, for example, as steam from a hot pressing process of the fiber molding process, the efficiency in the production of molded parts can be increased and the process stability significantly improved. Increasing the temperature can have different, positive effects for different process media, each of which yields an optimization of individual process steps and therefore also the manufacturing method.

Increasing the temperature of a process medium can reduce the temperature difference between the process medium (e.g., pulp, compressed air for removing steam and pressed-out water, suction air for the suction of fibers and/or holding preforms) and a preform or fibers or molded part as well as a tool so that no undesired cooling of tool components and molded parts occurs. In addition, warmer air (e.g., above 30° C.) can have a higher saturation of water than, for example, air at room temperature (approx. 20° C.) so that more steam can thereby be removed, while at the same time the warmer process air reduces the cooling of a tool. This means, for example, that a tool does not have to be heated as much because the warm process medium (e.g., air) and a warm preform made from a heated pulp mean that tools are cooled less.

In further embodiments, the second process medium and the at least third process medium can be guided in a countercurrent or cocurrent through the first pipe assembly and the at least second pipe assembly. This makes it possible to significantly influence the heat transfer between the process media.

In further embodiments, the quantity and/or speed of the second process medium and/or the at least third process medium can be controlled according to the temperature of the first process medium, the second process medium, and the third process medium. This can be used to control the temperature of the process media, for example to keep the pulp and process air at a definable temperature level in a fiber molding process.

Further features, embodiments and advantages result from the following illustration of exemplary embodiments with reference to the figures.

### BRIEF DESCRIPTION OF THE FIGURES

In the drawings:

FIG. 1 depicts a schematic representation of a fiber processing device, according to some embodiments.

FIG. 2 depicts a schematic representation of energy management of a fiber molding device, according to some embodiments.

FIG. 3 depicts a schematic representation of a heat transfer concept in a pulp tank, according to some embodiments.

FIG. 4 depicts a schematic representation of a heat exchanger in a pulp tank of a fiber molding device, according to some embodiments

FIG. 5 depicts a schematic sectional view of a heat exchanger, according to some embodiments.

FIG. 6 depicts schematically the heat transfer between different process media in a manufacturing method for fiber-containing molded parts, according to some embodiments.

### DETAILED DESCRIPTION

Various embodiments of the technical teaching described herein are shown below with reference to the figures. Identical reference signs are used in the figure description for identical components, parts and processes. Components, parts, and processes that are not essential to the technical teachings disclosed herein or that are obvious to a person skilled in the art are not explicitly reproduced. Features specified in the singular also include the plural unless explicitly stated otherwise. This applies in particular to statements such as “a” or “one.”

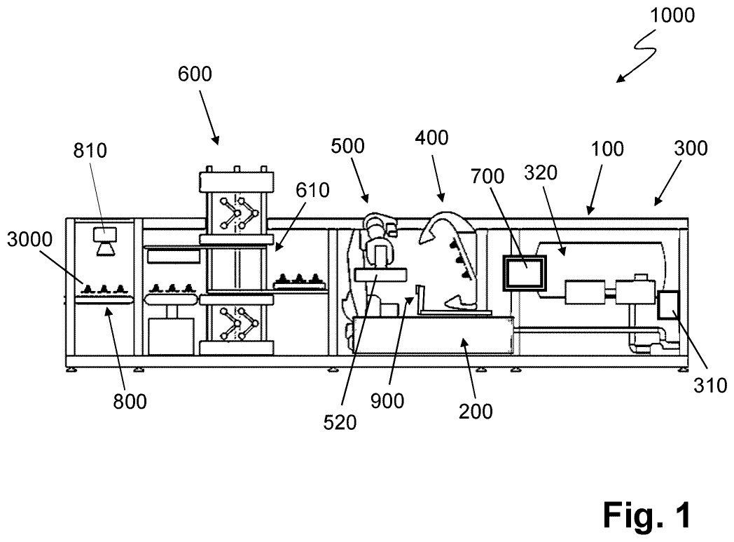

FIG. 1 shows a schematic representation of a fiber processing device 1000 for producing three-dimensional molded parts from a fiber-containing material, according to some embodiments. In the illustrated embodiment, the fiber-containing material for the production of molded parts is processed in a pulp tank 200 of the fiber processing device 1000. For this purpose, water and fibrous materials as well as additives, if any, can be introduced into a pulp tank 200 via a liquid supply, and the pulp can be prepared in the pulp tank 200 by mixing the individual components with heat input and by auxiliary means, such as an agitator.

Pulp refers to an aqueous solution containing fibers, where the fiber content of the aqueous solution can be in a range of 0.1 to 10 wt. %. In addition, additives such as starch, chemical additives, wax, etc. can be present. The fibers can be, for example, natural fibers, such as cellulose fibers, or fibers from a fiber-containing original material (for example waste paper). A fiber treatment plant offers the possibility of preparing pulp in a large quantity and providing pulp to several fiber processing devices 1000.

The fiber processing device 1000 can be used to produce, for example, biodegradable cups 3000, capsules, trays, plates, and other molded and/or packaged parts (e.g., as holder/supporting structures for electronic appliances). Since a fibrous pulp with natural fibers is used as the starting material for the products, the products manufactured in this way can themselves be used as a starting material for the manufacture of such products after their use, or they can be composted, because they can usually be completely decomposed and do not contain any substances that are harmful to the environment.

The fiber processing device 1000 shown in FIG. 1 has a frame 100 that can be surrounded by a cladding. The supply units 300 of the fiber processing device 1000 include, for example, interfaces for the supply of media (for example, water, pulp, compressed air, gas, etc.) and energy (power supply), a central control unit 310, at least one suction device 320, line systems for the various media, pumps, valves, lines, sensors, measuring devices, a bus system, etc., and interfaces for bidirectional communication via a wired and/or wireless data connection. Instead of a wired data connection, there can also be a data connection via a fiber optic line. The data connection can be, for example, between the control unit 310 and a central controller for multiple fiber processing devices 1000, to a fiber preparation plant, to a service point, and/or further devices. It is also possible to control the fiber processing device 1000 via a bidirectional data connection via a mobile device, such as a smartphone, tablet computer, or the like.

The control unit 310 is in bidirectional communication with an HMI panel 700 via a bus system or a data connection. The HMI (Human Machine Interface) panel 700 has a display that displays operating data and states of the fiber processing device 1000 for selectable components or the entire fiber processing device 1000. The display can be designed as a touch display so that adjustments can be made manually by an operator of the fiber processing device 1000. Additionally or alternatively, further input means, such as a keyboard, a joystick, a keypad, etc. for operator inputs, can be provided on the HMI panel 700. In this way, settings can be changed and the operation of the fiber processing device 1000 can be influenced.

The fiber processing device 1000 has a robot 500. The robot 500 is designed as a so-called 6-axis robot and is thus able to pick up parts within its radius of action, to rotate them and to move them in all spatial directions. Instead of the robot 500 shown in the figures, other handling devices can also be provided that are designed to pick up and twist or rotate products and move them in the various spatial directions. In addition, such a handling device may also be otherwise configured, in which case the arrangement of the corresponding stations of the fiber processing device 1000 may differ from the illustrated embodiment.

A suction tool 520 is arranged on the robot 500. In the illustrated embodiment, the suction tool 520 has cavities formed as negatives of the three-dimensional molded parts to be formed, such as of cups 3000, as suction cavities. The cavities can have, for example, a net-like surface on which fibers from the pulp are deposited during the suction. Behind the net-like surfaces, the cavities are connected to a suctioning device via channels in the suction tool 520. The suction device can be realized, for example, by a suction device 320. Pulp can be suctioned in via the suction device when the suction tool 520 is located within the pulp tank 200 in such a way that the cavities are at least partially located in the aqueous fiber solution, the pulp. A vacuum, or a negative pressure, for suctioning fibers, when the suction tool 520 is located in the pulp tank 200 and the pulp, can be provided via the suction device 320. For this purpose, the fiber processing device 1000 has corresponding means at the supply units 300. The suction tool 520 has lines for providing the vacuum/negative pressure from the suction apparatus 320 in the supply units 300 to the suction tool 520 and the openings in the cavities. Valves are arranged in the lines, which can be controlled via the control unit 310 and thus regulate the suction of the fibers. It is also possible for the suction device 320 to perform a “blow-out” instead of a suction, for which purpose the suction device 320 is switched to another operating mode in accordance with its design.

In the production of molded parts made of a fiber material, the suction tool 520 is immersed in the pulp and a negative pressure/vacuum is applied to the openings of the cavities so that fibers are suctioned out of the pulp and are deposited for example on the net of the cavities of the suction tool 520.

Thereafter, the robot 500 lifts the suction tool 520 out of the pulp tank 200 and moves said tool together with the fibers that are adhering to the suction cavities and still have a relatively high moisture content of, e.g., over 80 wt. % water, to the pre-pressing station 400 of the fiber processing device 1000, where the negative pressure is maintained in the suction cavities for the transfer. The pre-pressing station 400 has a pre-pressing tool with pre-pressing molds. The pre-pressing molds can be formed, for example, as positive of the molded parts to be manufactured and have a corresponding size with regard to the shape of the molded parts for receiving the fibers adhering in the cavities.

In the production of molded parts, the suction tool 520 is moved, with the fibers adhering in the cavities, to the pre-pressing station 400 in such a way that the fibers are pressed into the cavities. The fibers are pressed together in the cavities, so that a stronger connection is thereby produced between the fibers. In addition, the moisture content of the preforms formed from the suctioned-in fibers is reduced, so that the preforms formed after the pre-pressing only have a moisture content of, for example, 60 wt. %. To squeeze out water, flexible pre-pressing molds can be used, which are inflated, for example, by means of compressed air (process air), thereby pressing the fibers against the wall of a cavity of a further suction tool part. As a result of the “inflation,” both water is squeezed out, and the thickness of the sucked-in fiber layer is reduced.

During pre-pressing, liquid or pulp can be extracted and returned via the suction tool 520 and/or via further openings in pre-pressing molds or pre-pressing tool parts (cavities). The liquid or pulp discharged during suction via the suction tool 520 and/or during pre-pressing in the pre-press station 400 can be returned to the pulp tank 200.

After pre-pressing in the pre-pressing station 400, the preforms produced in this way are moved to a hot pressing station 600 on the suction tool 520 via the robot 500. For this purpose, the negative pressure is maintained at the suction tool 520 so that the preforms remain in the cavities. The preforms are transferred via the suction tool 520 to a lower tool body that can be moved along the production line out of the hot pressing device 610. If the lower tool body is in its extended position, the suction tool 520 is moved to the lower tool body in such a way that the preforms can be placed on forming devices of the lower tool body. Subsequently, an overpressure is produced via the openings in the suction tool 520 so that the preforms are actively deposited by the cavities, or the suction is ended, so that the preforms remain on the forming devices of the lower tool body due to gravity. By providing overpressure at the openings of the cavities, pre-pressed preforms that rest/adhere in the cavities can be released and dispensed.

Thereafter, the suction tool 520 is moved away via the robot 500 and the suction tool 520 is dipped into the pulp tank 200 in order to suction further fibers for the production of molded parts from fiber-containing material.

After the transfer of the preforms, the lower tool body moves into the hot pressing station 600. In the hot pressing station 600, the preforms are pressed into finished molded parts under heat and high pressure, for which purpose an upper tool body is brought onto the lower tool body via a press. The upper tool body has cavities corresponding to the forming devices. After the hot pressing operation, the lower tool body and the upper tool body are moved away relatively from one another and the upper tool body is moved along the fiber processing device 1000 in the manufacturing direction, where after hot pressing the manufactured molded parts are suctioned in via the upper tool body and thus remain within the cavities. Thus, the manufactured molded parts are brought out of the hot pressing station 600 and deposited via the upper tool body after the deposition on a transport belt of a conveyor device 800. After the deposition, the suction via the upper tool body is ended and the molded parts remain on the transport belt. The upper tool body moves back into the hot pressing station 600 and a further hot pressing operation can be carried out.

The fiber processing device 1000 further has a conveying device 800 with a transport belt. The manufactured molded parts made of fiber-containing material can be placed on the transport belt after the final molding and the hot pressing in the hot pressing station 600 and discharged from the fiber processing device 1000. In further embodiments, after placing the molded parts on the transport belt of the conveying device 800, further processing can take place, such as filling and/or stacking the products. The stacking can take place, for example, via an additional robot or another device.

The fiber processing device 1000 from FIG. 1 shows a possible embodiment. A fiber processing device according to the technical teaching described herein can also have only one forming station with a replaceable tool, e.g., a suction tool 520 or a hot press tool, in which fiber-containing material can be processed, it being possible for different tools for producing different three-dimensional molded parts to be received in the at least one forming station. The further stations and devices shown for the fiber processing device 1000 of FIG. 1 are not absolutely necessary for implementing the technical teaching.

In the fiber processing device 1000 in the illustrated embodiment, the steam arising during hot pressing in the hot pressing device 610 during operation is removed via a piping system and fed to a heat exchanger 900. In the heat exchanger 900, heat is transferred between the introduced hot steam and a process medium involved in the manufacturing process. Process media can be, for example, not exclusively the aqueous fiber solution (pulp), process air (compressed air for inflating flexible prepressing mold bodies, or (compressed) air for discharging steam during the hot pressing process. The relevant process media are heated or preheated. Preheating means, for example, that the fibers from the pulp and the water sucked into the preforms as well as the process air, which can additionally flow through the preforms in the hot press for steam discharge, are additionally heated due to the relatively high tool temperature of the hot press tools (e.g., 180-250° C.). The heating in at least one heat exchanger 900 generally only achieves heating or preheating, where the preheating does not achieve the temperature difference between an ACTUAL temperature of the process media before a heat transfer in the heat exchanger 900 and a TARGET temperature after the hot pressing process. In the illustrated embodiment, for example, the pulp can be increased from room temperature (approx. 20° C.) to between 2° and 60° C. and the process air can be increased from room temperature (approx. 20° C.) to between 30 and 80° C. Preheating process air and fluids (e.g., pulp) in hot pressing stations 600 and pre-pressing stations 400 can significantly improve efficiency in the production of three-dimensional molded parts and process stability.

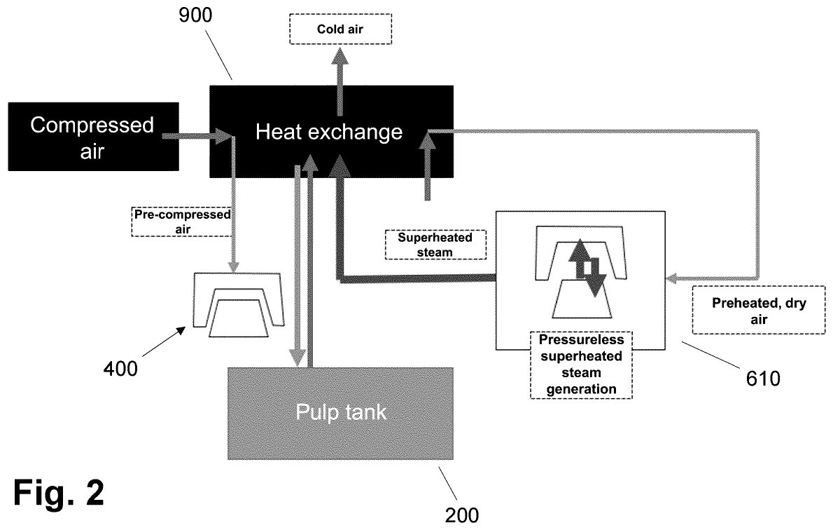

FIG. 2 shows a schematic representation of energy management of a fiber molding device 1000, according to some embodiments.

During the production of three-dimensional molded parts made of a fiber-containing material that is provided in an aqueous fiber solution, by heating bound and unbound water in the preforms, energy is converted in the form of superheated steam and removed. In the past, this superheated steam was condensed and removed in separate apparatuses such as tube bundle condensers by feeding in fresh water. The heat capacity of the cool fresh water leads to condensation of the steam.

The technical teaching described herein significantly increases the efficiency of the manufacturing process by recycling the condensation energy or the energy stored in the hot steam (depending on the pressure, approx. 90-120° C.), where the process air and/or the prepressing compressed air and/or the pulp mixture use the energy stored in the steam and are heated. This can be done, for example, using a heat exchange medium (gas, gas mixture (e.g., air), liquid, etc.).

The heating of the process media involved in the manufacturing method of three-dimensional molded parts from of a fiber-containing material can have different effects depending on the process medium.

### Process Air (Hot Pressing Device 610):

During the hot pressing process, the arising steam is removed via channels in the hot press tools. In order to support the removal of hot steam during the hot pressing process, (ambient) air can be supplied, which can flow through a hot press tool of the hot pressing device 610 and thereby entrain or remove the sucked steam. By preheating this process air, the temperature distribution and the energy balance in the hot press tool are positively influenced, and the hot press tool is not unnecessarily cooled at various points by excessively cold ambient air (process air). In addition, the effect of improved steam absorption by warm, dry air can be used, which also positively affects the energy requirement. The above measure results in a slight cooling of the hot press tool so that the heating power for the hot press tools can also be lower.

### Process Air (Prepressing Station 400):

Targeted preheating of prepressing air (process air) in a prepressing station 400 means that the preformed filter cake (preform) is already significantly warmed up instead of cold, expanding compressed air flowing through it, as is common in the prior art, which cools the filter cake.

In addition, the effect that pre-heated prepressing air (e.g., >30° C.) dehumidifies pulp of any type while prepressing significantly better than cold prepressing air (e.g., 20° C.) also comes into play here.

### Pulp Temperature (Pulp Tank 200):

By preheating the pulp in the pulp tank 200, the dissolving behavior of fiber materials and additives is positively influenced. In addition, the not yet pre-pressed filter cake (preform) sucked by the suction tool 520 is transported to the pre-pressing station 400 already heated, where, in turn, heated pre-pressing air can act efficiently so that significantly more water can be discharged compared to known manufacturing methods from the prior art. The preforms prepressed in this way can, for example, have a moisture content of approx. 50-63% by weight of water, whereas in the prior art, a moisture content of approx. 63-70% by weight of water could be achieved.

The increase in efficiencies (more efficient use of available thermal energy) can have an effect, for example, of around 5-15% of the total energy balance of a fiber processing device 1000. In addition, no cooling media need to be supplied or removed from the outside to condense discharged hot steam from the hot pressing process. The increase in energy efficiency can be directly leveraged to increase the output or reduce the energy consumption of the fiber processing device 1000.

The optimization of the manufacturing method described herein can be implemented, for example, by means of an apparatus for heat exchange in the exhaust steam flow (triple heat exchanger in the pulp tank), where the hot steam is conducted via a heat-conducting pipe in the pulp tank 200, and the pulp is heated via the pipe wall. A further, heat-conducting pipe with a smaller diameter in which process air is guided can run in the interior of the pipe. The process air can, for example, be conducted in cocurrent or countercurrent to the steam passing through. The above-described pipe assembly can be extended by further pipes guided in the interior of the pipe with the largest diameter so that any number of process media can be heated thereby. For high heat transfer, the pipe assembly within a pulp tank 200 can at least partially span a bottom surface and/or run along side wall sections and/or within a pulp tank 200.

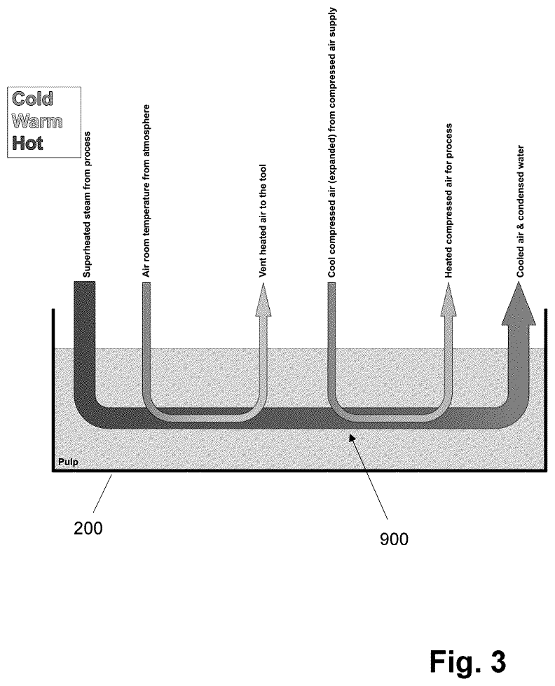

FIG. 3 shows a schematic representation of a heat transfer concept in a pulp tank 200, according to some embodiments. The concept has a quadruple heat exchanger 900 in which steam condensation of the hot steam from the hot pressing process is used to heat process air, heat prepress air and heat pulp. For this purpose, the hot steam is fed into the heat exchanger 900 via a piping system in which a pipe assembly according to the above embodiment can run.

In the shown concept, steam arising during the hot pressing process condenses on the inner walls of a pipe, for example, where its condensation energy is fed back into the manufacturing process for molded parts via the energy forms of pulp temperature, preheated process air and compressed air.

In further embodiments, the process media of air, pulp and water can also be heated externally by separate apparatuses. Energy can be supplied from outside for this purpose. Such apparatuses can be, for example, fan heaters, heating coils, etc.

In the illustrated embodiment, the energy released in the hot pressing process step and stored in the steam is used to (pre) heat process media via a heat exchanger 900. In so doing, energy is recovered by condensing another process medium that is present here as hot steam.

The schematic diagram in FIG. 3 shows how, by introducing hot steam from the hot pressing process into a pulp tank 200, the thermal energy, for example by condensation of the steam on the walls of a pipe assembly, can be used for heat exchange between different process media. In the shown example, process air can be introduced at different points for different process steps so that, for example, the required energy demand of the different process media can thereby be taken into account.

Control and switching devices such as conveyors (e.g., pumps, ventilators, etc.) and valves can be used to control and regulate both the amount of steam and the amount of process media introduced via corresponding piping systems. The quantity and also the flow rate can be regulated according to the temperature of the respective process media, their saturation (e.g., water) and/or their pressure. In so doing, other measuring devices in the fiber processing device 1000 can also be coupled, where, for example, the temperature of tools and the environment are taken into account. In addition, the temperature, saturation and/or pressure of the (pre) heated process media can be monitored continuously or sectionally. In the event of deviations or changes to process settings, an adjustment can be made, for example to achieve higher preheating that can lead to an increased saturation capacity of process air.

In the operation of a fiber processing device 1000 for molding fiber-containing material for the production of three-dimensional molded parts, pulp can first be provided, as described at the beginning. Fibers are sucked out of the pulp via a suction tool 520 and formed into three-dimensional molded parts via a pre-pressing station 400 and a hot-pressing station 600. The steam arising or released during hot pressing is sucked through openings in the cavities of the hot press tool and led out of the hot press tool via channels. This can be supported by introduced process air. The moist process air (steam) is then fed via a piping system to a heat exchanger 900 that can be arranged in a pulp tank 200, for example. The heat exchanger 900 is used at least to heat the pulp so that fibers, filter cakes and preforms that have a higher temperature are provided for the subsequent manufacturing method right from the start, so that the additional energy input to reach process temperatures is reduced. In addition to heating pulp, the heat exchanger 900 can also be used to preheat the process air for removing steam and for preforming.

The heating of the pulp means that preforms can already be sucked and provided that have a higher temperature than conventional preforms and therefore do not lead to cooling of the tool during a subsequent hot pressing process, or only to a lesser extent. Furthermore, the preforms have a lower temperature difference to the required hot pressing temperature. During the hot pressing process, process air (e.g., compressed air) is also introduced that transports the steam escaping from the preforms out of the cavities of the tool, or supports the removal of steam via corresponding channels in the tool. Warmer, introduced process air enables better removal of steam since warmer air can have a higher saturation of water.

In further embodiments, multiple process media can be heated in a definable sequence according to the amount of available energy. This means, for example, that a first process medium that has a higher energy requirement or requires a higher absolute temperature or whose temperature difference between an ACTUAL temperature before heating and a TARGET temperature to be achieved in a process step is the greatest, can be heated first using the waste heat from the hot pressing process, for example. Further process media can be subsequently heated, where the heat transfer to the first process medium means that only a lower heat capacity or amount of energy is available for further process media.

In further embodiments, the sequence can be selected according to the absolute temperature and/or a temperature difference of the process media and/or the steam, where this allows the amount of energy or the available waste heat, e.g., from a hot pressing process by the steam, to be specifically taken into account with regard to the amount of energy required to heat different process media. For example, the waste heat from a hot pressing process can initially be used for a heat exchange or heat transfer for the pulp in order to increase the temperature of the pulp. The remaining heat can then be used to heat the process air. In still further embodiments, simultaneous heating of multiple process media can also take place, where different degrees of heating occurs due to different heat transfers resulting from the heat transfer coefficients and the type of existing process and heat exchange medium as well as the primary heat medium (steam).

In further versions, multiple process media can be heated independently of each other. In this regard, for example, the steam can be supplied in equal or unequal amounts to different heat exchangers that each provide a heat transfer for their respective assigned process medium independently of the other heat exchangers. In still further embodiments, heating can also take place via a common heat exchanger or a common heat exchange medium, where there is no weighting or prioritization of the process media among each other.

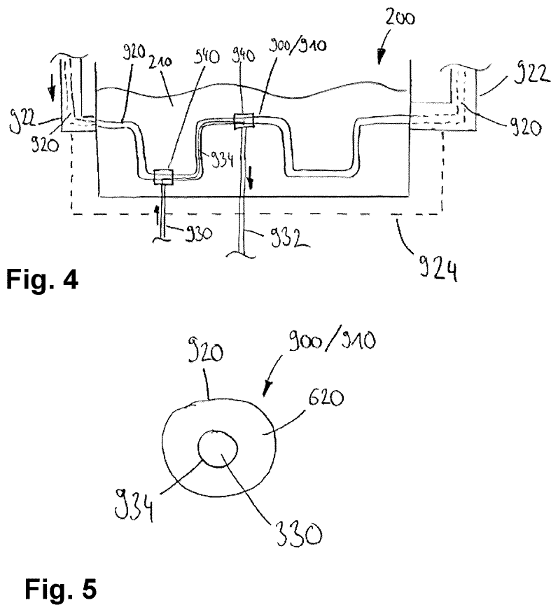

FIG. 4 shows a schematic representation of an exemplary embodiment with a heat exchanger 900 that is accommodated in a pulp tank 200 of a fiber processing device 1000.

Pulp 210 is received into the pulp tank 200 as the first process medium. The pulp 210 has an initially specified proportion of fibers in an aqueous solution and possibly further additions (additives, etc.). An apparatus for mixing (e.g., agitator etc.) can be arranged in the pulp tank 200 in order to mix the fibers and any additives continuously or intermittently.

A first pipe assembly 920 is connected to the pulp tank 200 in which hot steam 620 is supplied from a hot pressing process. The hot pressing process takes place in the hot pressing device 610 of a hot pressing station 600 of a fiber processing device 1000. The steam 620 escaping from the preforms is extracted from the cavities of a hot press tool. To support this, an auxiliary air flow (process air) can be introduced that flows through the hot press tool and entrains the steam, thereby supporting the steam discharge. This humid air flow represents a second process medium that has a relatively high temperature (e.g., 160 to 250° C.). From the hot pressing station 600 to the pulp tank 200, the first pipe assembly 920 and/or a feed tube may have insulation 922 so that no significant heat is dissipated to the environment or to the fiber processing device 1000.

Within the pulp tank 200, the first pipe assembly 920 has no insulation 922 and can release the thermal energy stored in the second process medium to the pulp 210 (first process medium). For this purpose, the first pipe assembly 920 is designed to be thermally conductive at least within the pulp tank 200 and has a high heat transfer coefficient. In further embodiments, the first pipe assembly 920 and a double pipe assembly 910 within the pulp tank 200 are made of a thermally conductive metal. Within the pulp tank 200, the first pipe assembly 920 is connected to at least one second pipe assembly via connecting elements 940. A third process medium (e.g., process air) is introduced from the outside via a feed 930 of the second pipe assembly and heated within the pulp tank 200 and in particular in the section 934 within the double pipe assembly 910. The second pipe assembly is inserted into the first pipe assembly 920 and run out via the connecting elements 940. In the section between the two connecting elements 940 shown in FIG. 4, a heat exchanger 900 is designed as a double-pipe assembly 910, as shown schematically in FIG. 5, for example. In further embodiments, a double pipe assembly 910 can extend through the entire pulp tank 200, where the inlet and outlet of at least one second pipe assembly into the first pipe assembly 920 are outside the pulp tank 200. The first pipe assembly 920 and the second pipe assembly can be designed as a corrugated pipe and have a large surface for heat transfer between the process media within the path in the pulp tank 200. FIG. 4 schematically indicates that the first pipe assembly 910 and the double pipe assembly 910 meander through the pulp tank 200 in order to provide the longest possible path for heat transfer. In further embodiments, the first pipe assembly 920 and the double pipe assembly 910 can also have other routes and orientations. For example, the first pipe assembly 920 and the double pipe assembly 910 can also run like a helix through the pulp tank 200.

The second process medium passed through the heat exchanger 900 and the pulp tank 200 releases the thermal energy to the first process medium and the third process medium and cools down in the process. The cooled second process medium is then led out of the pulp tank 200 via the first pipe assembly 920. In this case, the first pipe assembly 920 can have a bypass via which there is a return 924 of cooled second process medium after the exit of the second process medium from the pulp tank 200. The cooled second process medium can, for example, be partially returned to the inlet of the first pipe assembly 920 before entering the pulp tank 200 via a return 924. The amount of returned second process medium in the feed of the first pipe assembly 920 before entering the pulp tank 200 can be controlled via a valve or another switching device. The remaining part of the second process medium that is led out of the pulp tank 200 can, for example, be discharged into the atmosphere, where the second process medium generally has a lower temperature after the heat exchanger 900 and is therefore harmless. In further embodiments, a separator can be provided upstream from an outlet of the second process medium, which filters out residual water from the cooled process air (second process medium). Such water can, for example, be introduced into the pulp tank 200 in further embodiments.

The embodiment described above provides a heat transfer in the pulp tank 200 as well as within the section between the connecting elements 940 in the double pipe assembly 910 via the pipe assemblies made of of a heat-conducting material so that, depending on the temperature of the introduced second process medium and the temperature of the other process media, heat is released over the path of the double pipe assembly 910 or the heat exchanger 900 by condensation of the hot steam on the pipe walls of the pipe assemblies. The heat transfer in the double pipe assembly 910 or in the heat exchanger 900 also essentially depends on the diameter that the individual pipe assemblies have and the speed or pressure at which the process media are introduced. Furthermore, the heat transfer depends on whether the individual process media are introduced in countercurrent or cocurrent. Valves/switching apparatuses and conveying devices for providing a defined delivery rate per unit time can also have a significant influence on the extent to which heat transfer takes place. In further embodiments, multiple further process media can also be introduced through corresponding connecting elements 940 or throughout the entire path within a pulp tank 200 into a double pipe assembly 910 with multiple pipes accommodated within a first pipe assembly 920 so that any desired heat transfers can be adjusted for different process media.

In further embodiments, a defined temperature or a definable temperature range can be maintained for the entire manufacturing process by specifically controlling the temperatures and flow rates for individual process media, such as the pulp 210.

FIG. 5 shows a schematic sectional view through a heat exchanger 900 or the double pipe assembly 910 with a first pipe assembly 920. The first pipe assembly 920 has a larger diameter than the section 934 of the second pipe assembly that is accommodated within the double pipe assembly 910. A third process medium, for example process air 330, is guided in the interior of the second pipe assembly or the section 934. Steam 620 is introduced as a second process medium between the outer surface of section 934 and the inner surface of the first pipe assembly 920. The second pipe assembly, the first pipe assembly 920 are located within a pulp 210 during operation and therefore release thermal energy stored in the steam 620 to the pulp 210 via the outer surface of the first pipe assembly 920.

In further embodiments, a further pipe assembly can be arranged within the second pipe assembly. Furthermore, in further embodiments, in addition to a single further pipe assembly within the section 934, multiple second pipe assemblies can extend parallel to each other within the first pipe assembly 920. In still further embodiments, multiple second pipe assemblies can also be twisted together. The steam 620 guided in the region between the first pipe assembly 920 and the at least one second pipe assembly and the process air 330 can be passed through in countercurrent or cocurrent, as explained above, in order to thereby influence the heat transfer.

The method described herein not only provides a significant increase in the efficiency of the entire fiber processing device 1000, but also increases the efficiency of hot pressing processes. In addition, an increase in process stability and product quality is achieved because thermal fluctuations are present due to the consistently higher temperature of the process media, where the overall temperature difference between the initial temperature and the process temperature is reduced for all processes. The at least one process medium is heated using energy released during the molding of fiber-containing material in a process step, where released energy can be used recuperatively, and the overall energy requirement can therefore be reduced. In addition, the heating of process media itself reduces the energy requirement, e.g., for hot pressing devices 610 so that a significant overall improvement in the energy balance can be achieved.

In so doing, at least one process medium can be heated using the condensation energy of steam arising in a process step, where the steam released under pressure and at high temperatures (>160° C.) during the pressing of preforms into molded bodies from a fiber-containing material can be advantageously used to heat process media. In this way, the thermal energy of the steam, which is not used conventionally, is fed into the production process or one of the process steps so that the overall energy requirement is reduced, and the efficiency is increased.

The apparatus described herein for the multiple heat exchanging of arising process waste heat in fiber processing devices 1000 and the associated return of the energy have a strong positive influence on the efficiency and process stability of the overall process.

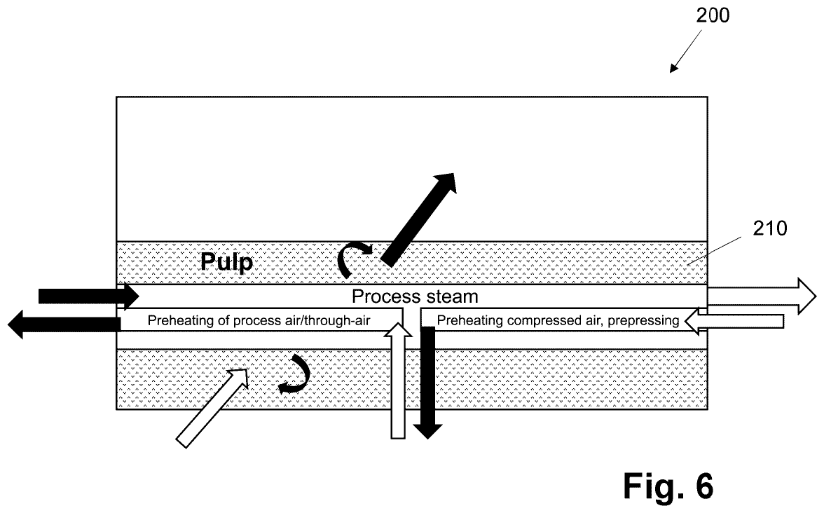

FIG. 6 schematically shows the heat transfer between different process media in a manufacturing method for fiber-containing molded parts according to some embodiments (black arrows correspond to high temperature/energy; white arrows correspond to low temperature/energy).

By preheating the process through-air (process medium) that is fed to the hot press tool to remove steam, an asymmetrical temperature distribution in hot press tools can be converted to a symmetrical temperature distribution. The advantage of preheating the process through-air is that dry hot air absorbs more steam than cold through-air. Furthermore, the preheating of the process through-air ensures that preheated hot through-air, that is heated in advance via a heat exchanger 900, does not cool the hot press tool on one side during ventilation.

Preheating the process compressed air also makes it possible to provide preheated compressed air during prepressing, where the filter cake is preheated, resulting in improved dewatering. Preheating the process compressed air therefore also causes a reduced cooling of the prepress tool during product blow-off.

In addition, preheating the pulp causes improved processing since warm pulp is easier to process in terms of the material properties of the fibers than pulp at an ambient temperature (e.g., 20° C.). A higher pulp temperature results in finer fibers, better absorption of additives (saturation), better dewatering for pre-pressing, and a warmer filter cake (less energy required in the hot press).

### LIST OF REFERENCE SIGNS

100 Frame
200 Pulp tank
210 Pulp
300 Supply units
310 Control unit
320 Suction device
330 Process air
400 Pre-pressing station
500 Robot
520 Suction tool
600 Hot pressing station
610 Hot pressing device
620 Steam
700 HMI panel
800 Conveying device
810 Camera
900 Heat exchanger
910 Double pipe assembly
920 First pipe assembly
922 Insulation
924 Return
930 Feed (second pipe assembly)
932 Return (second pipe assembly)
934 Section
940 Connecting element
1000 Fiber processing device
3000 Cup

1. An apparatus for heating process media in a fiber molding process, having a double pipe assembly made of an at least sectionally heat-conducting material, wherein at least a heat-conducting section of the double pipe assembly is accommodated in a container that is filled with a first process medium, wherein the double pipe assembly has at least a first pipe assembly and at least a second pipe assembly, wherein the first pipe assembly has a larger diameter than the second pipe assembly, and the second pipe assembly is accommodated at least sectionally within the first pipe assembly, further having connections for connecting the double pipe assembly to units for providing process media, wherein the second pipe assembly is configured to guide a second process medium within the second pipe assembly, and the first pipe assembly is configured to guide a third process medium within the first pipe assembly.

2. The apparatus according to claim 1, wherein at least a third pipe assembly is arranged at least sectionally within the first pipe assembly and/or within the second pipe assembly.

3. The apparatus according to claim 1, wherein the second pipe assembly within the container opens into the first pipe assembly in a receiving space for a first process medium and/or is led out of the first pipe assembly.

4. The apparatus according to claim 1, wherein the diameter of the first pipe assembly and/or the second pipe assembly vary within the container.

5. The apparatus according to claim 1, wherein the first pipe assembly and the second pipe assembly have separately controllable connections for introducing and discharging process media.

6. The apparatus according to claim 1, wherein a quantity and speed of the process media introduced into the double pipe assembly is controlled separately.

7. The apparatus according to claim 1, wherein the first pipe assembly and/or the second pipe assembly are designed as a corrugated pipe at least in a region of the container in a receiving space for a first process medium.

8. A method for heating process media in a fiber molding process using an apparatus with a double pipe assembly made of a material that conducts heat at least sectionally, wherein at least a heat-conducting section of the double pipe assembly is accommodated in a container that is filled with a first process medium, wherein the double pipe assembly has at least a first pipe assembly and at least a second pipe assembly, wherein the first pipe assembly has a larger diameter than the second pipe assembly, and the second pipe assembly is accommodated at least sectionally within the first pipe assembly, the apparatus further having connections for connecting the pipe assembly to units for providing process media, wherein a second process medium is guided within the second pipe assembly, and a third process medium is guided within the first pipe assembly, and wherein the second process medium guided in the first pipe assembly is supplied from a process step of the fiber molding process at a higher temperature, and wherein the temperature of the second process medium is higher than the temperature of the first process medium and the third process medium guided in the second pipe assembly.

9. The method according to claim 8, wherein the second process medium and the third process medium are guided in countercurrent or cocurrent through the first pipe assembly and the second pipe assembly.

10. The method according to claim 8, wherein a quantity and/or speed of the second process medium and/or the third process medium are controlled according to the temperature of the first process medium, the second process medium, and the third process medium.
